(19) United States
(12) Patent Application Publication
(10) Pub. No.: US 2008/0302006 A1
(43) Pub. Date: Dec. 11, 2008

(54) Method and Container for Substrate-Free Cultivation of a Germination Product

(75) Inventors: Cornelus Albertus Joseph Hurkx, Bemmel (NL); Jelle Jacob Kuijper, Gendt (NL)

Correspondence Address: THE WEBB LAW FIRM, P.C., 700 KOPPERS BUILDING, 436 SEVENTH AVENUE, PITTSBURGH, PA, 15219, US

(73) Assignee: FLITWICK B.V., Oosterhout Nijmegen (NL)

(21) Appl. No.: 12/096,148

(22) PCT Filed: Dec. 7, 2005
(86) PCT No.: PCT/NL2005/050067

§ 371 Date: Jun. 4, 2008

(51) Int. Cl. A01G 31/06

(52) U.S. Cl. 47/61; 47/59 R

(57) ABSTRACT

A method for substrate-free cultivation of a germination product, comprising the steps of accommodating a bean or seed in a chamber, for example in a container; setting the conditions in the chamber, such as humidity and temperature, in such a way that the bean is made to sprout; providing the chamber with a restraining means, wherein the restraining means interact with the shell of the bean or the seed in such a way that the shell is kept in the chamber while a shoot of the bean or the seed or emerges from the chamber.

The invention relates to the production of germination products. Examples of such germination products are, for example, bean sprouts, alfalfa, beetroot shoots, leek shoots and the like, but the invention is not confined to these products. Bean sprouts, for example, come from mung beans which are normally made to sprout in perforated, stainless steel trays. During germination oxygen is consumed and carbon dioxide produced. Germination is a combustion process, in which heat is therefore released. So the mung beans are sprayed in the stainless steel trays, in such a way that, among other things, the heat generated can be removed in a controlled manner.

The beans or seeds are normally tipped into the stainless steel trays in a fairly thick layer. During germination the volume of the seedlings increases, giving rise to a considerably thicker layer. Its thickness increases until the product is fully grown. After this, harvesting takes place, this layer being scooped out of the trays for further processing, such as removal of the seed shell and the root. This further processing can be carried out in vibrating troughs, through which the harvested product is conducted.

Finally the product has to be divided into portions into, for example, the crates which are delivered to the buyer. It is also known to pack the product in flexible bags. It is impossible to avoid damage occurring during this harvesting, cleaning and packing of the product. This is disadvantageous, since it has an adverse effect on the freshness and shelf life of the product.

Another way of cultivating such germination products is disclosed in U.S. Pat. No. 5,636,474. In this the beans in question are accommodated in a container constructed from a number of grids with a net clamped in between them. Beans are placed on the net in a single layer in such a way that during their germination the roots become entangled in the net. These roots then grow downwards into the bottom grid, while the shoots grow upwards through the top grid. The germination products are therefore fixed with respect to the net after they have put out roots. The shoots then have to reach full development in the top grid, with the intention of then being able to harvest a clean, fully-grown product. In connection with said harvesting a flat blade can be inserted through the container to cut the shoots away from the roots.

However, in spite of the fact that the roots become stuck in the net, there will be the problem that the shell of the beans and/or parts of the roots are also pushed upwards when the shoots grow. This is less desirable since only the shoots are suitable for consumption.

The known container further has so-called growing grids, which have channels aligned with respect to the grid openings in the grids between which the net is clamped. The shoots have to be guided into these channels in the growing grids in such a way that the fully-grown shoots can ultimately be harvested. However, even these so-called growing grids cannot prevent unwanted plant parts such as the shell and parts of the roots also being forced upwards during the growth of the shoots.

The aim of the invention is therefore firstly to provide a method by means of which clean germination products can be harvested that contain no seed shell and parts of roots. A further aim is to avoid manipulation of the shoots and to make the moment of harvesting coincide with the moment of use, thereby significantly improving the shelf life of the grown shoots. These aims are achieved by means of a method for substrate-free cultivation of a germination product, comprising the following steps:
accommodating a bean or seed in a chamber, for example in a container,
setting conditions in the chamber, such as humidity and temperature, which encourage the bean to sprout,
providing the chamber with restraining means,
making the restraining means interact with the shell of the bean or the seed in such a way that the shell is kept in the chamber while the shoot can emerge from the chamber.

The method according to the invention for cultivating the germination products differs from the method according to the prior art in that measures have been taken to hold the seed shell back from the germination product, which seed shell comes away after the bean begins to sprout. The result of these measures is that the harvested shoots are clean and not contaminated by adhering pieces of shell and the like. This produces a clean product immediately suitable for consumption and also suitable for immediate use by the general public. The measures for holding back the seed shell are also suitable for holding back other contaminants possibly adhering to the shoots, such as dirt and the like, which further beneficially influences the quality of the harvested product. The product also remains undamaged in the container.

The measure for holding back the seed shell and the like can be effected in various ways. To this end, according to a first option, the method according to the invention comprises the step of making the bean or the seed interact with a wall or walls of the chamber. In this respect the wall or the walls of the chamber can, for example, have an appropriate roughness, such that the shell is prevented from moving with the developing shoot by frictional interaction. But other measures are also possible, such as sharp, slightly protruding parts on the wall or walls, which have the same effect.

According to yet another option, the method according to the invention comprises the step of making the shell of the bean interact with a flexible covering provided on the top of the chamber. This flexible covering can likewise be made and attached in many different ways. According to a first option the invention comprises the step of using a flexible covering with a passage or potential passage. Via this passage or potential passage the shoot can more easily grow outwards and upwards, out of the chamber, while the shell is, as it were, stripped from the growing shoot by the covering.

The invention also relates to a container for carrying out the method described above, with which, on the one hand, the growth of shoots can be guaranteed and which, on the other hand, has a beneficial effect on the quality of the harvested products. In particular, by means of this container it is possible to guarantee that the fully-grown shoots are not damaged and contaminated with parts of the shell and/or the roots. This objective is achieved by providing the chamber with a restraining means for holding back a quantity of beans or seeds accommodated in the chamber and/or the shell and/or the root of said beans or seeds and to provide passage for shoots growing out of the beans or seeds to outside the chamber.

Therefore, with the container according to the invention the quantity of beans can be kept reliably in the chamber(s) concerned. An advantage of this is, moreover, that once the beans have been put in they can no longer fall out. As the beans grow, the first portion of the shoot comes into contact with the restraining means. As the shoot grows further the restraining means give in such a way that the shoot is able to make a passage, but any adhering parts of the shell and/or the root are held back.

In this context it is important that the growth of the shoot is not disturbed and also that the shoot does not become damaged when the restraining means are pushed aside. These restraining means must therefore not only provide the correct retaining effect, but also be able to allow passage of the shoot in a smooth manner. This can be achieved, for example, by a restraining means comprising a layer of film. However, other embodiments of the restraining means are also possible, such as, for example, a restraining means made of a sponge-like material.

With the aim of disturbing the growing process of the shoots as little as possible, the restraining means can have openings, such as slits, made in advance. However, it is not always necessary to make openings in advance; the restraining means can, for instance, also have weakened regions, such as score lines, made in advance. While the shoot is growing it comes into contact with the layer of film and the like weakened in this way, as a result of which the layer of film opens at the location of the weakened regions and can provide passage for the shoots.

The container according to the invention is particularly suitable for cultivating germination products by means of the so-called ebb and flow system. With a system of this type the containers are placed on a flat sheet over which water is regularly fed in such a way that a relatively high water level can be provided temporarily. During this period the beans can absorb water, after which the water level is lowered. In connection with such an application the floor of the container is preferably permeable to water. This can be achieved, for example, by providing the floor with openings. These openings are preferably slot-shaped; the width of the slot-shaped openings must in this case be smaller than the dimensions of a bean.

Furthermore, the chamber can have a width which approximately coincides with the dimension of a bean and a length which is a multiple of the dimension of a bean. With regard to efficient cultivation of a large number of germination products, the container is preferably made with a row of several chambers next to one another. In particular at least two rows of several chambers can be provided, the chambers of the one row being in the extension of the chambers of the other row.

These chambers are preferably accommodated in a base element, which can, for example, be made of plastic. In particular, such a base element can be injected-moulded inexpensively.

The invention furthermore relates to a pack comprising a container as described above as well as an enclosure that extends upwards from the chamber(s). The height of this enclosure can be approximately the same as the dimensions of a fully-grown shoot, such that that the shoots can be supported and protected in a stable manner during growth.

The invention will be explained in more detail below with reference to an illustrative embodiment shown in the figures.

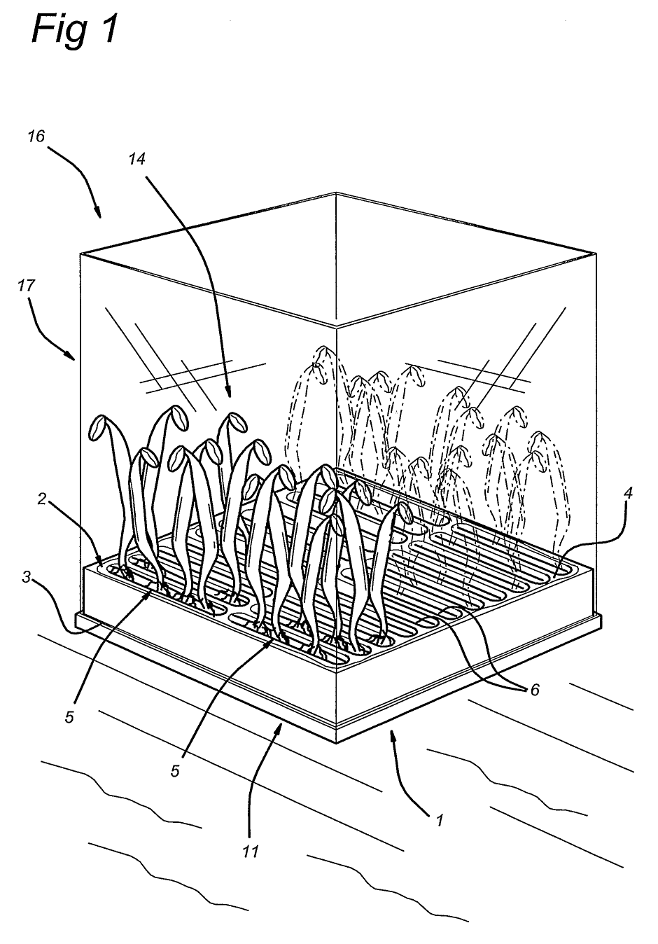

FIG. 1 shows a perspective view of a complete pack, including base element, according to the invention.

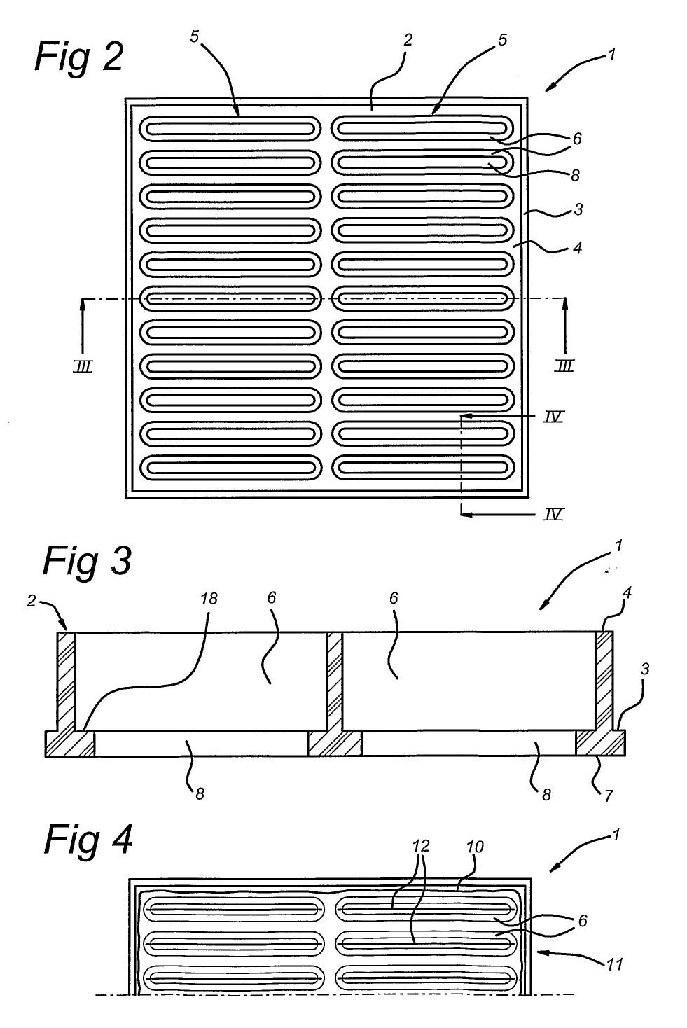

FIG. 2 shows a partial plan view of the base element according to FIG. 1.

FIG. 3 shows a cross-section according to III-III in FIG. 2.

FIG. 4 shows a partial plan view of the container according to the invention, consisting of a base element according to FIG. 1 with a film applied thereto.

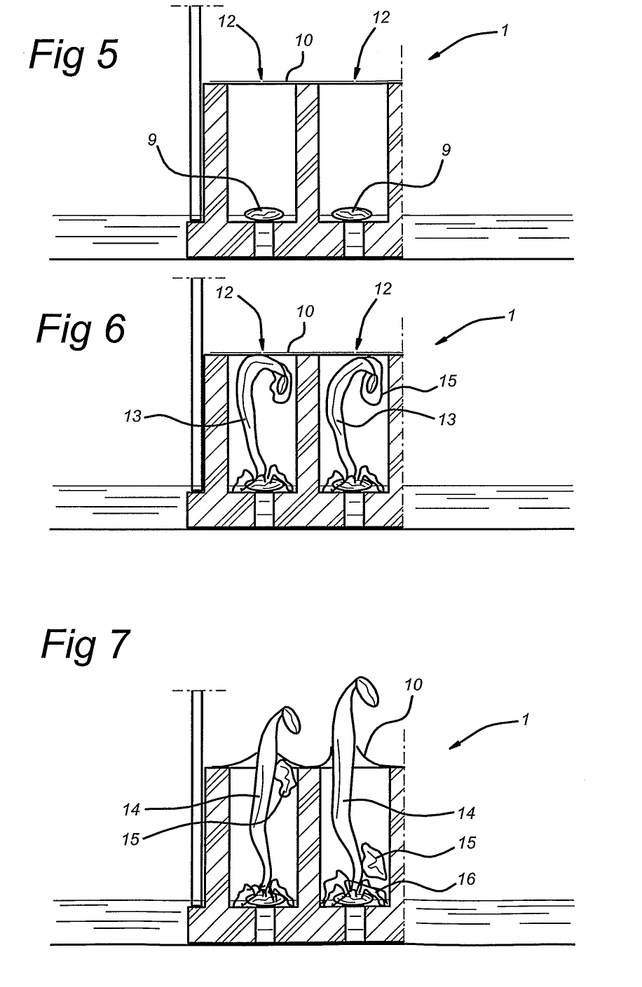

FIG. 5 shows a cross-section according to V-V in FIG. 4, with a number of beans.

FIGS. 6 and 7 show a cross-section corresponding to that in FIG. 5, this time with beans in various stages of development.

FIG. 1 shows a complete pack 16 that consists of a container 11, an enclosure 17 and a quantity of fully-grown shoots 14. The enclosure 17 is placed on a foot 3. The base element 1 according to the invention, also shown in this FIG. 1, is made of an injection-moulded plastic. This base element 1 consists of a base body 2 and has the broadened foot 3 at the bottom. Two rows 5 of elongated chambers 6 extend from the upper surface 4 of the base body 2. As can be seen in FIGS. 4 and 6, these chambers 6 do not extend completely as far as the underside 7 of the base body 1, but are delimited by a floor 18. The chambers 6 do, though, open out on the underside 7 via the likewise elongated but narrower openings 8. The mutual and transverse dimensions of the chamber 6 and the openings 8 are also shown in the plan view in FIG. 2.

Beans 9 can be accommodated in these chambers 6, as shown in FIG. 6. The transverse dimensions of the chambers' 6 are such that the beans fit into them one after the other. However, the transverse dimensions of the openings 8 are smaller than the dimensions of the beans 9, such that they are trapped therein. However, water can enter the chambers 6 via the openings 8 in connection with the germination of the beans 9. The water can be fed, for example, by means of a so-called ebb and flow system, wherein the base body is arranged on a flat base which from time to time is flooded with water.

A film 10 is attached, for example by gluing, to the top 4 of the base body 1 after the beans 9 have been put into the chambers 6. By means of this film 10 it is possible to ensure that the beans 9 remain in the chambers 6 and cannot fall out of the chambers during further treatment. The container 11 thus obtained by applying the film 10 is then ready for use in a cultivation area, in particular as described above in combination with an ebb and flow system.

This container 11 is also shown in the plan view in FIG. 4. The film 10 has been applied to the upper surface 4 of the base element 1. In each case, coinciding with the chambers 6, a slit 12 is provided, the aim of which is shown in FIGS. 5-7. When the beans 8 sprout, the shoot 13 that has just developed initially comes into contact with the underside of the film 10: see FIG. 6. As growth continues, this shoot 13 can push open the opening 12, as is also shown in FIG. 7 in the case of the now more fully-grown shoots 14. In this context the film 10 needs to be flexible enough for the shoots 14 not to be damaged in the process. Another result of the film 10 is that the shell 15, which comes from the beans 9, is held back. This means that the shell 15, and possibly also parts of roots 16 or dirt, do not move upwards with the shoot, which is beneficial for the quality of the product.

1-26. (canceled)

27: A method for substrate-free cultivation of a germination product, comprising the steps of:
accommodating a bean or seed having a shell in a chamber;
setting growing conditions including humidity and temperature in the chamber to cause the bean to sprout;
providing the chamber with a restraining means;
causing the restraining means to interact with the shell of the bean or the seed, such that the shell is contained in the chamber while a shoot growing from the bean or seed emerges from the chamber.

28: The method according to claim 27, further comprising the step of causing the shell of the bean or the seed to interact with a wall or walls of the chamber via friction.

29: The method according to claim 27, further comprising the step of causing the shell of the bean or the seed to contact a flexible covering provided on a top of the chamber.

30: The method according to claim 29, wherein the flexible covering includes a passage for accommodating the shoot therethrough.

31: A container for substrate-free cultivation of a germination product, comprising:
at least one chamber for accommodating a quantity of beans or seeds;
a floor defined in at least one of the chambers; and
a restraining means situated on or within the chamber for holding back the shell of the beans or seeds, wherein the restraining means include a passage for accommodating a shoot growing from the bean or seed therethrough to allow the shoot to emerge from the chamber.

32: The container according to claim 31, wherein the restraining means comprises a layer of film.

33: The container according to claim 31, wherein the restraining means comprises a sponge-like material.

34: The container according to claim 32, wherein the layer of film includes at least one slit defined therein.

35: The container according to claim 32, wherein the layer of film includes a predefined score line.

36: The container according to claim 31, wherein the floor is water-permeable.

37: The container according to claim 36, wherein the floor includes at least one slot-shaped openings.

38: The container according to claim 37, wherein the width of the slot-shaped opening is smaller than the width of the bean or the seed.

39: The container according to claim 31, wherein the width of the chamber is substantially the same width as that of the bean or the seed, and wherein the chamber has a length which is a multiple of the length of the bean or the seed.

40: The container according to claim 31, further comprising a first row of a plurality of chambers.

41: The container according to claim 40, further comprising a second row of a plurality of chambers, wherein the second row is adjacent to the first row.

42: The container according to claim 41, wherein the height of the at least one chamber is at least the same height as that of the bean or the seed.

43: The container according to claim 41, wherein the height of the at least one chamber is a multiple of the height of the bean.

44: The container according to claim 43, further comprising a base for accommodating the first and second row of the plurality of chambers therein.

45: The container according to claim 44, wherein the base element is constructed of injection-molded plastic.

46: A pack comprising:
a container for substrate-free cultivation of a germination product, comprising:
a first and second row of a plurality of chambers, wherein the second row is adjacent to the first row, wherein each of the chambers are sized to accommodate a bean or seed, wherein the height of each of the chambers is at least the same height as that of the bean or the seed;
a floor defined in each of the chambers; and
a restraining means situated on or within each of the plurality of chambers for holding back the shell of the beans or seeds, wherein the restraining means include a passage for accommodating a shoot growing from the bean or seed therethrough to allow the shoot to emerge from the chamber;
a base for accommodating the first and second row of the plurality of chambers therein; and
an enclosure that upwardly extends from the first and second row of the plurality of chambers.

47: The pack according to claim 46, wherein the height of the enclosure is substantially the same as the height of the shoot when fully grown of one or more of the beans or seeds to be accommodated within one or more of the chambers.
